(19) United States
(12) Patent Application Publication
(10) Pub. No.: US 2006/0158992 A1
(43) Pub. Date: Jul. 20, 2006

(54) Optical recording device

(76) Inventor: Hiroshi Sakai, Nagano (JP)

Correspondence Address: CANTOR COLBURN, LLP, 55 GRIFFIN ROAD SOUTH, BLOOMFIELD, CT, 06002, US

(21) Appl. No.: 11/335,015

(22) Filed: Jan. 18, 2006

(30) Foreign Application Priority Data
Jan. 19, 2005 (JP) 2005-012109
Jul. 4, 2005 (JP) 2005-194953

(51) Int. Cl. G11B 7/00

(52) U.S. Cl. 369/112.01; 369/44.41

(57) ABSTRACT

An optical recording device for use with an optical recording disk includes a laser light source, a photo-detector which is provided with a plurality of light receiving faces, and an optical system which forms a return path for guiding a return light beam reflected by an optical recording disk to the photo-detector. A sensor lens which is disposed at a middle position of the return path of the optical system is provided with a plurality of divided lens surfaces whose focal lengths differ from each other and which guide the return light beam to different positions on the photo-detector. The plurality of light receiving faces of the photo-detector receive the return light beams which are guided by the plurality of divided lens surfaces, and a focusing error signal is generated on the basis of respective light receiving results in the plurality of light receiving faces of the photo-detector.

### CROSS REFERENCE TO RELATED APPLICATIONS

The present invention claims priority under 35 U.S.C. §119 to Japanese Application No. 2005-12109 filed Jan. 19, 2005 and Japanese Application No. 2005-194953 filed Jul. 4, 2005, both of which are incorporated herein by reference.

### FIELD OF THE INVENTION

An embodiment of the present invention may relate to an optical recording device which performs reproduction and/or recording of information recorded on an optical recording disk. More specifically, an embodiment of the present invention may relate to an optical recording device suitable for performing recording of information on a DVD-RAM or other format.

### BACKGROUND OF THE INVENTION

Various structures have been proposed to detect a signal from an optical recording disk. Even when either structure is adopted, an optical recording device includes basically a laser light source, a photo-detector, and an optical system which forms a forward path for guiding a laser beam emitted from the laser light source to an optical recording disk and a return path for guiding a return light beam reflected by the optical recording disk to the photo-detector.

In such an optical recording device, information recorded on an optical recording disk is reproduced based on a signal detected with a photo-detector and a focusing error signal and a tracking error signal are also generated. As a method for performing the focusing error detection, the astigmatism method has been often used. In the astigmatism method, as shown in FIG. 4(E), a light receiving face is divided into four divided light receiving faces, i.e., a first, a second, a third and a fourth divided light receiving faces A′, B′, C′, and D′. A focusing error signal is generated based on a difference between the sum of the detection signals in the divided light receiving faces A′, C′ and the sum of the detection signals in the divided light receiving faces B′, D′. In other words, as shown in FIGS. 4(D) and 4(F), in the case of unfocused state, a focusing error signal is generated by utilizing unbalance between the sum of the detection signals in the divided light receiving faces A′, C′ and the sum of the detection signals in the divided light receiving faces B′, D′.

A guide groove for tracking has been previously formed on an optical recording disk such as a DVD-RAM before recording is performed and thus a tracking error signal can be generated by utilizing a push-pull signal generated from the guide groove for tracking even in an optical recording disk in which information is not recorded. The push-pull signal is obtained by a diffracted light that is generated from the guide groove for tracking and reaches to the quadripartite light receiving face of a photo-detector.

However, the diffracted light from the guide groove for tracking may not have an appropriate orientation due to manufacturing variation of an optical recording device and producing variation of an optical recording disk, which causes the diffracted light not to reach to the appropriate position of the quadripartite light receiving face. As a result, the push-pull signal may leak into a focusing error signal and in this case, an appropriate focusing error signal cannot be generated. Such a cross-talk is referred to as a focusing error/tracking error cross-talk, which causes a focus servo and a seek operation to be unstable. Therefore, although a further fine servo condition is required in comparison with the case where an optical recording disk for reproduction is used, for example, an offset is required to be set in a gain in servo, such a fine servo condition has not been attained yet.

### BRIEF DESCRIPTION OF THE INVENTION

In view of the problems described above, an embodiment of the present invention may advantageously provide an optical recording device which is suitable for recording of information to a DVD-RAM and the like without occurring unstable operation due to the focusing error/tracking error cross-talk.

Thus, according to an embodiment of the present invention, there may be provided an optical recording device including a laser light source, a photo-detector which is provided with a plurality of light receiving faces, and an optical system which forms a forward path for guiding a laser beam emitted from the laser light source to an optical recording disk and a return path for guiding a return light beam reflected by the optical recording disk to the photo-detector. The optical system includes a sensor lens which is disposed at a middle position of the return path of the optical system. The sensor lens is provided with a plurality of divided lens surfaces whose focal lengths differ from each other and which guide the return light beam to different positions on the photo-detector. The plurality of light receiving faces of the photo-detector receives the return light beams guided through the plurality of divided lens surfaces, and a focusing error signal is generated on the basis of respective light receiving results in the plurality of light receiving faces of the photo-detector.

In accordance with an embodiment of the present invention, in order to utilize the beam size method in which a focusing error signal is generated on the basis of comparison result of the beam sizes of the return light beams which are guided to the photo-detector, a sensor lens, which is provided with a plurality of divided lens surfaces whose focal lengths differ from each other and which guides the return light beam to different positions on the photo-detector, is disposed at a middle position of the return path of the optical system. Therefore, even when a diffracted light generated from a guide groove for tracking does not reach to the appropriate position of the light receiving face due to inappropriate orientation based on manufacturing variation of an optical recording device or producing variation of an optical recording disk, the push-pull signal does not leak into a focusing error signal. Accordingly, unstable operation due to the focusing error/tracking error cross-talk does not occur and thus information can be surely recorded on a DVD-RAM or the like.

In accordance with an embodiment, the plurality of divided lens surfaces of the sensor lens includes two divided lens surfaces whose boundary extends in one of a tracking direction and a jitter direction of the optical recording disk, and the focal lengths of the two divided lens surfaces differ from each other.

In accordance with an embodiment, the plurality of divided lens surfaces of the sensor lens includes two divided lens surfaces whose boundary extends in the tracking direction of the optical recording disk, and focal lengths of the two divided lens surfaces differ from each other.

In accordance with an embodiment, the sensor lens is, for example, provided with a first, a second, a third and a fourth divided lens surfaces which are arranged in a cross-in-square shape. A boundary between the first divided lens surface and the second divided lens surface and a boundary between the third divided lens surface and the fourth divided lens surface are set to be in the jitter direction of the optical recording disk, and a boundary between the first divided lens surface and the fourth divided lens surface and a boundary between the second divided lens surface and the third divided lens surface are set to be in the tracking direction of the optical recording disk. Further, the focal lengths of the first divided lens surface and the third divided lens surface at diagonal positions each other are set to be coincided, and the focal lengths of the second divided lens surface and the fourth divided lens surface at diagonal positions each other are set to be coincided, and the focal length of the first divided lens surface, the third divided lens surface and the focal length of the second divided lens surface, the fourth divided lens surface are differed from each other.

In accordance with an embodiment, a return light beam emitted through the first divided lens surface and a return light beam emitted through the third divided lens surface are received at positions so as to be partially overlapped each other in the jitter direction of the optical recording disk, and a return light beam emitted through the second divided lens surface and a return light beam emitted through the fourth divided lens surface are received at positions so as to be partially overlapped each other in the jitter direction of the optical recording disk.

Further, in accordance with an embodiment, in order to compare the beam sizes of the return light beams which are guided to the photo-detector through the respective divided lens surfaces of the sensor lens, the photo-detector is provided a first, a second, a third and a fourth light receiving faces which are formed in a cross-in-square shape for receiving a return light beam guided through the sensor lens. In this photo-detector, a boundary between the first light receiving face and the second light receiving face and a boundary between the third light receiving face and the fourth light receiving face are extended in the jitter direction of the optical recording disk, and a boundary between the first light receiving face and the fourth light receiving face and a boundary between the second light receiving face and the third light receiving face are extended in the tracking direction of the optical recording disk. Further, the first light receiving face comprises a first divided light receiving area A₁ that is located on an opposite side to the second light receiving face and a second divided light receiving area A₂ that is located on a boundary area side with the second light receiving face. The second light receiving face comprises a first divided light receiving area B₁ that is located on a boundary side with the first light receiving face and a second divided light receiving area B₂ that is located on an opposite side to the first light receiving face. The third light receiving face comprises a first divided light receiving area C₁ that is located on a boundary side with the fourth light receiving face and a second divided light receiving area C₂ that is located on an opposite side to the fourth light receiving face. The fourth light receiving face comprises a first divided light receive area D₁ that is located on an opposite side to the third light receiving face and a second divided light receiving area D₂ that is located on a boundary area side with the third light receiving face.

In this case, the photo-detector is preferably formed such that a boundary line between the first divided light receiving area A₁ and the second divided light receive area A₂ of the first light receiving face is set at a position where a beam spot converged on the first light receiving face is equally divided each other at the focal position, a boundary line between the first divided light receiving area B₁ and the second divided light receive area B₂ of the second light receiving face is set at a position where a beam spot converged on the second light receiving face is equally divided each other at the focal position, a boundary line between the first divided light receiving area C₁ and the second divided light receive area C₂ of the third light receiving face is set at a position where a beam spot converged on the third light receiving face is equally divided each other at the focal position, and a boundary line of the first divided light receiving area D₁ and the second divided light receive area D₂ of the fourth light receiving face is set at a position where a beam spot converged on the fourth light receiving face is equally divided each other at the focal position.

According to the structure as described above, the focusing error signal is generated based on a difference between the sum of detection signals in the divided light receiving areas A₁, B₂, C₁, D₂, and the sum of detection signals in the divided light receiving areas A₂, B₁, C₂, D₁.

In the case as constructed above in accordance with an embodiment, a tracking error signal is obtained based on a difference between the sum of detection signals in the divided light receiving areas A₁, A₂, D₁, D₂, and the sum of detection signals in the divided light receiving areas B₁, B₂, C₁, C₂.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory schematic view showing an essential portion of an optical recording device in accordance with a first embodiment of the present invention.

FIG. 2(A) is a plan view showing a sensor lens which is used in the optical recording device in accordance with the first embodiment and FIG. 2(B) is an explanatory sectional view showing the sensor lens schematically.

FIG. 3 is an explanatory view showing a state where a return light beam from an optical recording disk is converged on a photo-detector through a sensor lens in the optical recording device in accordance with the first embodiment.

FIGS. 4(A) through 4(C) are explanatory views showing different states of the light receiving face of a photo-detector which is used in the optical recording device in accordance with the first embodiment 1, and FIGS. 4(D) through 4(F) are explanatory views showing different states of the light receiving face of a photo-detector in a conventional optical recording disk device when the astigmatism method is used.

FIGS. 5(A) through 5(C) are explanatory views showing an effect when astigmatism distortion is included in the return light beam from an optical recording disk in the optical recording device in accordance with the first embodiment, and FIGS. 5(D) through 5(F) are explanatory views showing an effect when astigmatism distortion is included in the return light beam from an optical recording disk in a conventional optical recording device.

FIG. 6 is an explanatory schematic view showing a portion of an optical recording device in accordance with a second embodiment of the present invention.

FIGS. 7(A) through 7(C) are explanatory views showing different states of the light receiving face of a photo-detector which is used in the optical recording device in accordance with the second embodiment.

FIG. 8 is an explanatory view showing a light receiving face when a return light beam from an optical recording disk is converged on a photo-detector through a sensor lens in an optical recording device in accordance with another embodiment of the present invention.

FIG. 9 is an explanatory view showing an optical recording device in accordance with another embodiment of the present invention.

### DESCRIPTION OF THE PREFERRED EMBODIMENTS

Embodiments of the present invention will be described below with reference to the accompanying drawings. In the drawings, for the purpose of indicating the positional relationship between the divided lens surface of a sensor lens and an optical recording disk, and the positional relationship between the light receiving face of an optical receiver and the optical recording disk, the tracking direction is shown with the arrow “Tr” and the jitter direction (tangential direction) is shown with the arrow “J”.

### First Embodiment

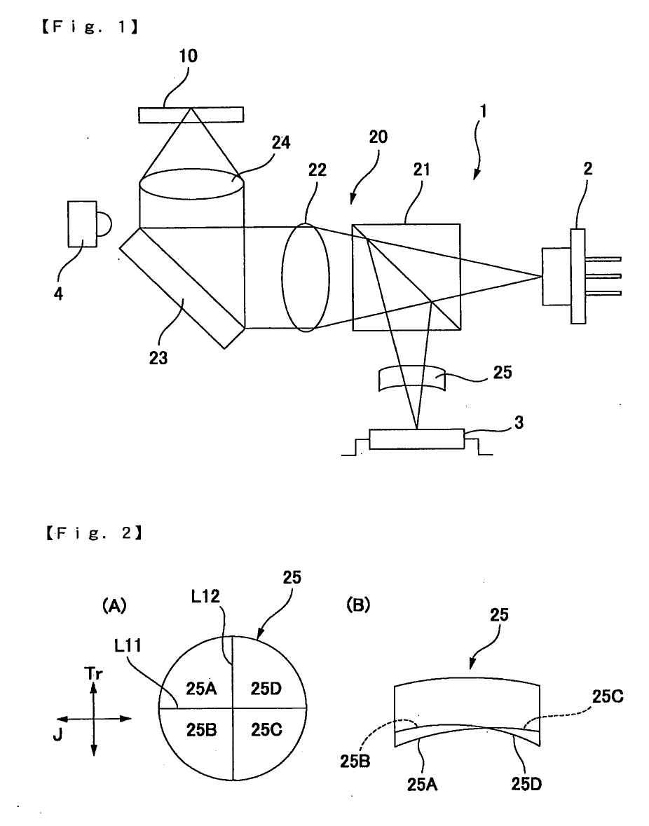

FIG. 1 is an explanatory schematic view showing an essential portion of an optical recording device in accordance with a first embodiment of the present invention.

In FIG. 1, an optical recording device 1 in accordance with the first embodiment includes a laser light source 2 which emits, for example, a laser light beam with a wavelength of 650 nm, and a photo-detector 3. The optical recording device 1 is also provided 10 with an optical system 20 including a beam splitter 21, a collimator lens 22, a raising mirror 23 and an objective lens 24 from the laser light source 2 to an optical recording disk. A forward path through which a laser beam emitted from the laser light source 2 is guided to the optical recording disk 10 is formed by these optical elements. The optical system 20 is also provided with a sensor lens 25 between the beam splitter 21 and the photo-detector 3. A return path through which a return light beam reflected from the optical recording disk is guided to the photo-detector 3 is formed by the objective lens 24, the raising mirror 23, the collimator lens 22, the beam splitter 21 and the sensor lens 25. The photo-detector 3 detects a return light beam reflected from the optical recording disk to generate a focusing error signal and a tracking error signal when information is recorded or reproduced. The focusing error signal and the tracking error signal are fed back to an objective lens drive device (not shown).

The optical recording disk 10 is but is not limited to, for example, a DVD-RAM or other format which may be obtained from many manufacturers to be used with the present invention. A land or surface which is wobbled (waved) and a groove are alternately formed (not shown in the drawings) in a concentric manner in the DVD-RAM. Both of the land and the groove are used as a track in which a pit is formed. A signal obtained from the wobble is used in the pull-in of a clock.

A front monitor 4 (photo-detector for monitor) is disposed behind the raising mirror 23 for detecting a light beam which is directed to the optical recording disk 10 from the laser light source 2 and leaked out from the raising mirror 23.

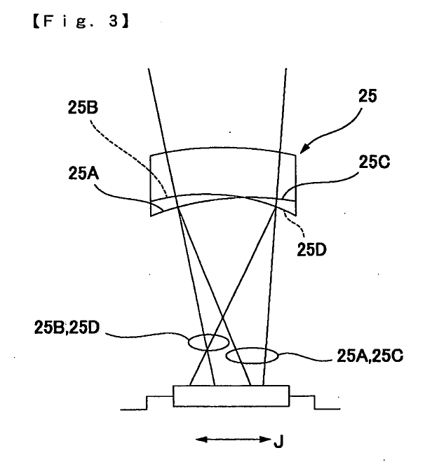

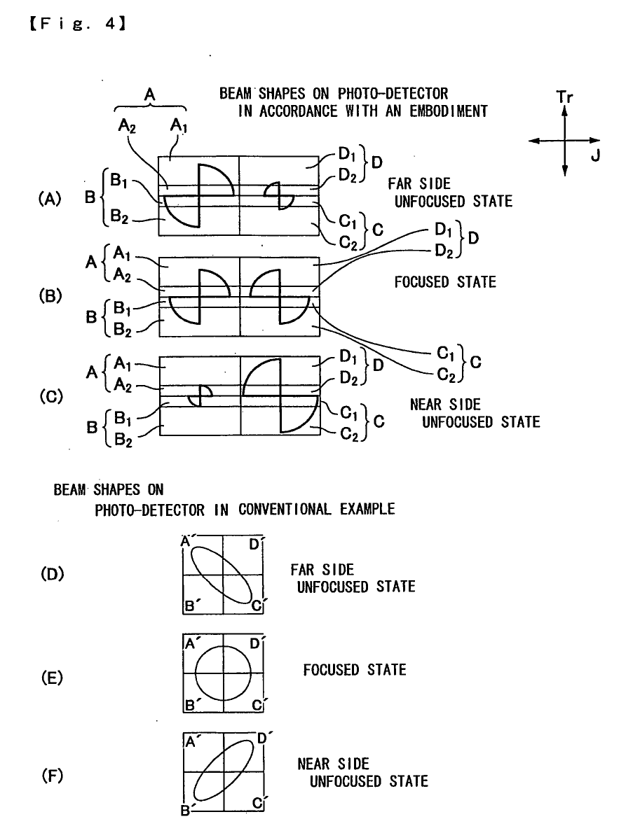

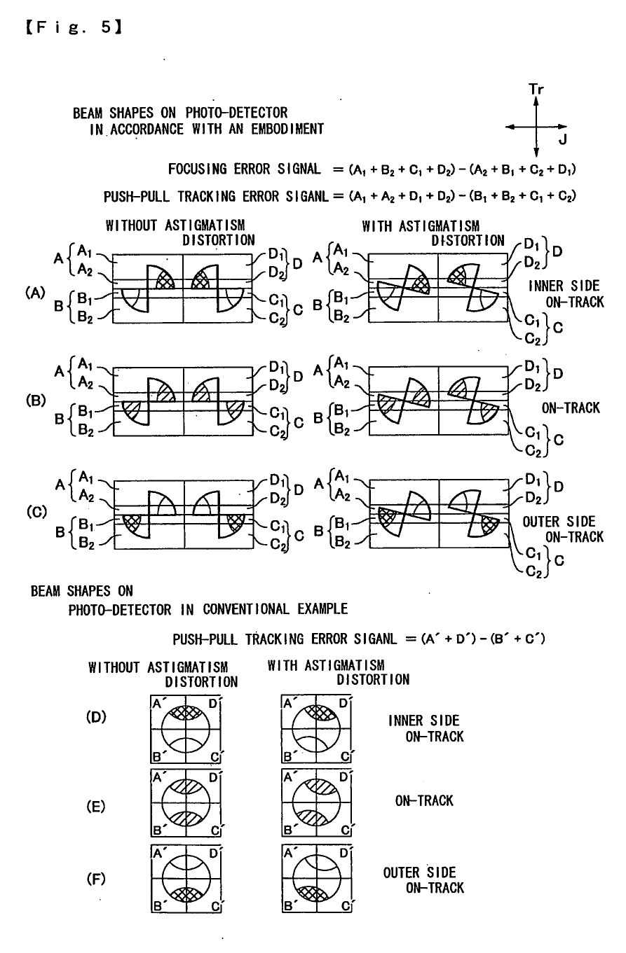

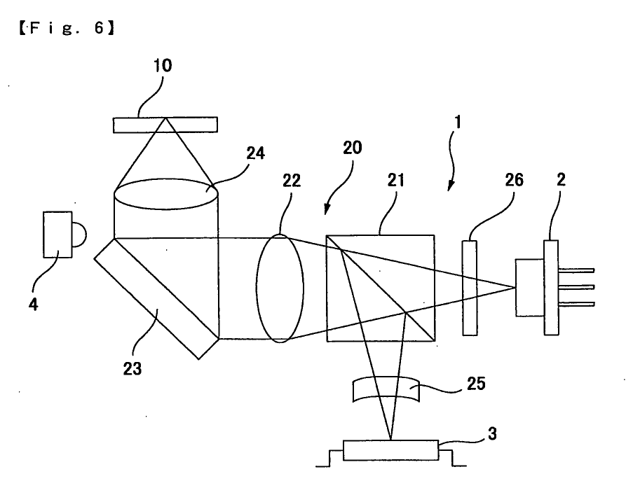

FIG. 2(A) is a plan view showing a sensor lens which is used in the optical recording device in accordance with the first embodiment and FIG. 2(B) is an explanatory sectional view showing the sensor lens schematically. FIG. 3 is an explanatory view showing a state where a return light beam from an optical recording disk is converged on a photo-detector through a sensor lens in the optical recording device in accordance with the first embodiment. FIGS. 4(A) through 4(C) are explanatory views showing different states of the light receiving face of the photo-detector which is used in the optical recording device in accordance with the first embodiment. FIGS. 5(A) through 5(C) are explanatory views showing an effect when astigmatism distortion is included in the return light beam from an optical recording disk in the optical recording device in accordance with the first embodiment, and FIGS. 5(D) through 5(F) are explanatory views showing an effect when astigmatism distortion is included in the return light beam from an optical recording disk in a conventional optical recording device.

In the optical recording device 1 shown in FIG. 1, the sensor lens 25 is a bifocal four-divided lens. The sensor lens 25 is, as shown in FIGS. 2(A), 2(B) and FIG. 3, provided with a first, a second, a third and a fourth divided lens surfaces 25A, 25B, 25C, 25D that are arranged in a cross-in-square shape. A step portion is formed at every boundary portion between the respective divided lens surfaces 25A, 25B, 25C, 25D. The directions of dividing lines L11, L12 in the sensor lens 25 are perpendicular to each other. In this embodiment, the dividing line L11 (the boundary between the first divided lens surface 25A and the second divided lens surface 25B, and the boundary between the third divided lens surface 25C and the fourth divided lens surface 25D) is set to be in a direction parallel to the tangential direction of the track of the optical recording disk 10 (jitter direction of the optical recording disk). The other dividing line L12 (the boundary between the first divided lens surface 25A and the fourth divided lens surface 25D, and the boundary between the second divided lens surface 25B and the third divided lens surface 25C) is set to be in a direction perpendicular to the tangential direction of the track of the optical recording disk 10 (tracking direction of the optical recording disk 10).

Each of the first, the second, the third and the fourth divided lens surfaces 25A, 25B, 25C, 25D has a positive power. The focal lengths of the first divided lens surface 25A and the third divided lens surface 25C in diagonal positions each other are set to be coincided, and the focal lengths of the second divided lens surface 25B and the fourth divided lens surface 25D in diagonal positions each other are set to be coincided. In addition, the focal length of the first divided lens surface 25A, the third divided lens surface 25C and the focal length of the second divided lens surface 25B and the fourth divided lens surface 25D are different from each other.

Therefore, as shown in FIG. 3, the laser beams emitted to the photo-detector through the first and the third divided lens surfaces 25A, 25C are focused on the back side (lower side in the drawing) of the photo-detector 3. On the other hand, the laser beam emitted to the photo-detector 3 through the second and the fourth divided lens surfaces 25B, 25D are focused on the front side (upper side in the drawing) of the photo-detector 3.

As shown in FIGS. 4(A) through 4(C), the photo-detector 3 is provided with a plurality of light receiving faces, i.e., a first, a second, a third and a fourth light receiving faces “A”, “B”, “C”, “D” which are formed in a cross-in-square shape for receiving a return light beam guided through the first, the second, the third and the fourth divided lens surfaces 25A, 25B, 25C, 25D. The boundary between the first light receiving face “A” and the second light receiving face “B” is extended in a jitter direction of an optical recording disk, and the boundary between the third light receiving face “C” and the fourth light receiving face “D” is also extended in the jitter direction of the optical recording disk. On the other hand, the boundary between the first light receiving face “A” and the fourth light receiving face “D” is extended in a tracking direction of the optical recording disk, and the boundary between the second light receiving face “B” and the third light receiving face “C” is also extended in the tracking direction of the optical recording disk. Therefore, a return light beam emitted through the first divided lens surface 25A is received in the fourth light receiving face “D”, a return light beam emitted through the second divided lens surface 25B is received in the second light receiving face “B”, a return light beam emitted through the third divided lens surface 25C is received in the third light receiving face “C”, and a return light beam emitted through the fourth divided lens surface 25D is received in the first light receiving face “A”.

Further, the first light receiving face “A” comprises a first divided light receiving area A 1 which is located on an opposite side to the second light receiving face B and a second divided light receiving area A₂ which is located on the boundary area side with the second light receiving face “B”. The second light receiving face “B” comprises a first divided light receiving area B₁ which is located on the boundary side with the first light receiving face “A” and a second divided light receiving area B₂ on the opposite side to the first light receiving face “A”. The third light receiving face “C” comprises a first divided light receiving area C₁ which is located on the boundary side with the fourth light receiving face “D” and a second divided light receiving area C₂ on the opposite side to the fourth light receiving face “D”. The fourth light receiving face D comprises a first divided light receive area D₁ which is located on an opposite side to the third light receiving face C and a second divided light receiving area D₂ which is located on the boundary area side with the third light receiving face C.

A boundary line between the first divided light receiving area A₁ and the second divided light receive area A₂ of the first light receiving face “A” is set at a position where a beam spot converged on the first light receiving face “A” is equally divided each other at the focal position. A boundary line between the first divided light receiving area B₁ and the second divided light receive area B₂ of the second light receiving face “B” is set at a position where a beam spot converged on the second light receiving face “B” is equally divided each other at the focal position. A boundary line between the first divided light receiving area C₁ and the second divided light receive area C₂ of the third light receiving face “C” is set at a position where a beam spot converged on the third light receiving face “C” is equally divided each other at the focal position. Further, a boundary line of the first divided light receiving area D₁ and the second divided light receive area D₂ of the fourth light receiving face “D” is set at a position where a beam spot converged on the fourth light receiving face “D” is equally divided each other at the focal position.

In the photo-detector 3 as constructed above, beams as shown in FIG. 4(B) are formed on four light receiving faces “A”, “B”, “C”, “D” at the time of focusing, beams as shown in FIG. 4(A) are formed at the time of the far side unfocused state, and beams as shown in FIG. 4(C) are formed at the time of the near side unfocused state.

Therefore, a focusing error signal is generated based on a difference between the sum of detection signals in the divided light receiving areas A₁, B₂, C₁, D₂, and the sum of detection signals in the divided light receiving areas A₂, B₁, C₂, D₁ in a plurality of the divided light receiving areas formed in the photo-detector 3. In other words, when signals which are respectively detected in the divided light receiving areas A₁, A₂, B₁, B₂, C₁, C₂, D₁, D₂ are expressed as signals A₁, A₂, B₁, B₂, C₁, C₂, D₁, D₂, the focusing error signal is obtained by the following expression:
(A₁+B₂+C₁+D₂)−(A₂+B₁+C₂+D₁)

On the other hand, when a tracking error signal is obtained by the push-pull method, the tracking error signal may be generated by the following expression:
(A₁+A₂+D₁+D₂)−(B₁+B₂+C₁+C₂)

When information is reproduced from an optical recording disk 10, information may be reproduced, for example, by the following expression:
(A₁+A₂+B₁+B₂+C₁+C₂+D₁+D₂).

As described above, in the optical recording device 1 in accordance with the first embodiment, a focusing error signal is generated by employing a beam size method which is based on the comparison results of the beam sizes of the return light beams that are guided to the photo-detector 3. In order to attain such a beam size method, in accordance with the first embodiment, the sensor lens 25, which is provided with a plurality of divided lens surfaces 25A, 25B, 25C, 25D with different focal lengths for guiding the return light beam to different positions on the photo-detector 3, is disposed at a middle position of the return path. Therefore, as described below with reference to FIGS. 5(A) through 5(C), even when a diffracted light generated from the guide groove for tracking does not reach to the appropriate position of the light receiving face due to inappropriate orientation based on manufacturing variation of an optical recording device 1 or producing variation of an optical recording disk 10, a focus servo and a seek operation can be performed in a stable state because the focusing-error/tracking-error cross-talk does not occur. Further, an offset is not required to be set in a gain in servo. Therefore, when information is recorded on a DVD-RAM or the like, a fine servo condition can be realized in comparison with the case where an optical recording disk for reproducing is driven.

Further, in the first embodiment, the sensor lens 25 is a bifocal and four-divided lens comprising the first, the second, the third and the fourth divided lens surfaces 25A, 25B, 25C, 25D which are arranged in a cross-in-square shape. Therefore, four beams respectively form independent spots on the photo-detector 3 and thus the directions of the four light receiving faces “A”, “B”, “C”, “D” of the photo-detector 3 can be easily matched to the sensor lens 25.

FIGS. 5(A), 5(B) and 5(C) respectively show a state where the astigmatism distortion does not occur and a state where the astigmatism distortion occurs in the optical recording device 1 in the first embodiment. In each of the states, spots formed on the photo-detector 3 are shown in the following cases; when a beam spot is formed on the inner side of a track of the optical recording disk 10, when a beam spot is formed at the center of a track of the optical recording disk 10, and when a beam spot is formed on the outer side of a track of the optical recording disk 10. Further, FIGS. 5(D), 5(E) and 5(F) respectively show a conventional state where the astigmatism distortion does not occur and a conventional state where the astigmatism distortion occurs. In each of the states, spots formed on the photo-detector 3 are shown in the following cases; when a beam spot is formed on the inner side of a track of the optical recording disk 10, when a beam spot is formed at the center of a track of the optical recording disk 10, and when a beam spot is formed on the outer side of a track of the optical recording disk 10. In the case of this conventional embodiment, a focusing error signal is generated on the basis of a difference between the sum of detection signals in the divided light receiving faces A′, C′ and the sum of detection signals in the divided light receiving faces B′, D′. Further, a tracking error signal is generated on the basis of a difference between the sum of detection signals in the divided light receiving faces A′, D′ and the sum of detection signals in the divided light receiving faces B′, C′.

In FIGS. 5(A) through 5(F), an area which is bright due to the astigmatism is expressed with void and an area which is dark is expressed with crossed oblique lines.

As recognized by comparing FIGS. 5(A) through 5(C) with FIGS. 5(D) through 5(F), in accordance with the first embodiment, unlike the case of using a conventional method, when an arithmetic operation to calculate a focusing error signal is performed, bright and dark due to the astigmatism are canceled and thus bright and dark does not affect on the calculation result of the focusing error signal. Consequently, generation of the focusing error/tracking error cross-talk is prevented.

For example, when a state where the center position of a spot on a DVD-RAM (optical recording disk 10) is located on a groove is set to be at a reference position, the ratio of the focusing error signal included in the push-pull signal (value corresponding to the focusing error/tracking error cross-talk) while the spot is shifted from the reference position by 0.37 μm (half of a track pitch) on an inner side or outer side of the optical recording disk 10 is obtained by a simulation. As a result, the ratio in the conventional method as shown in FIGS. 4(D) through 4(F) and FIGS. 5(D) through 5(F) is 8% but, in accordance with an embodiment of the present invention as shown in FIGS. 4(A) through 4(C) and FIGS. 5(A) through 5(C), it is confirmed that the ratio is reduced to 3%.

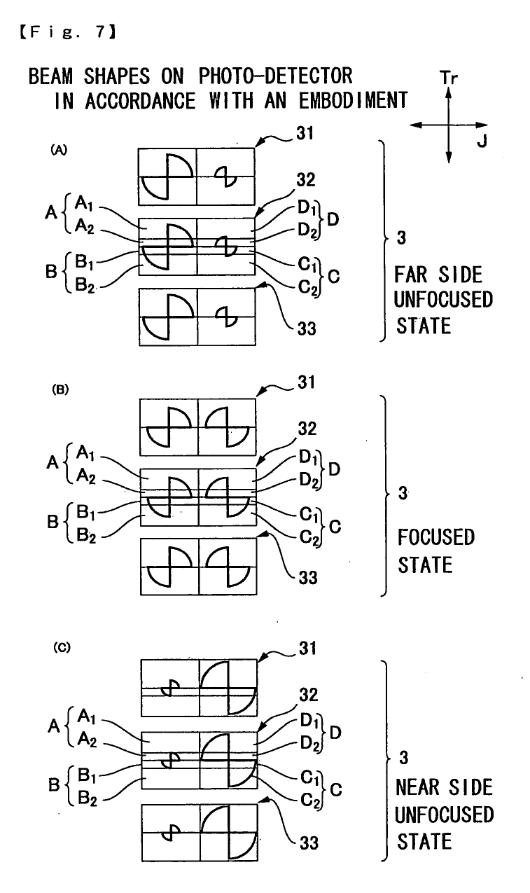

FIG. 6 is an explanatory schematic view showing al portion of an optical recording device in accordance with a second embodiment of the present invention. FIGS. 7(A) through 7(C) are explanatory views showing different states where a return light beam from the optical recording disk is converged on a photo-detector through a sensor lens in the optical recording device in accordance with the second embodiment. The basic structure in an optical recording device of the second embodiment is common to that in the optical recording device in accordance with the first embodiment. Therefore, the same notational symbols are used to illustrate the common portions and their descriptions are omitted.

Also in the optical recording device 1 in accordance with the second embodiment as shown in FIG. 6, a forward path for guiding the laser beam emitted from the laser light source 2 to the optical recording disk 10 and a return path for guiding a return light beam reflected by the optical recording disk 10 to the photo-detector 3 is structured by an optical system which is similar to the first embodiment.

The sensor lens 25 is a bifocal four-divided lens as described with reference to FIGS. 2(A), 2(B) and FIG. 3, and provided with the first, the second, the third and the fourth divided lens surfaces 25A, 25B, 25C, 25D which are arranged in a cross-in-square shape. A step portion is formed at every boundary portion between the respective divided lens surfaces 25A, 25B, 25C, 25D. Each of the first, the second, the third and the fourth divided lens surfaces 25A, 25B, 25C, 25D has a positive power. The focal lengths of the first divided lens surface 25A and the third divided lens surface 25C in diagonal positions each other are set to be coincided, and the focal lengths of the second divided lens surface 25B and the fourth divided lens surface 25D in diagonal positions each other are set to be coincided. In addition, the focal length of the first divided lens surface 25A, the third divided lens surface 25C and the focal length of the second divided lens surface 25B and the fourth divided lens surface 25D are differed from each other. Therefore, as shown in FIG. 3, the laser beams emitted to the photo-detector through the first and the third divided lens surfaces 25A, 25C are focused on the back side of the photo-detector 3. On the other hand, the laser beam emitted to the photo-detector 3 through the second and the fourth divided lens surfaces 25B, 25D are focused on the front side from the photo-detector 3.

In the second embodiment, the three-beam method is used for a tracking error signal and, as shown in FIG. 6, a grating 26 is disposed between the laser light source 2 and the beam splitter 21. Therefore, in this embodiment, as shown in FIGS. 7(A), 7(B) and 7(C), the photo-detector 3 is provided with a first light receiving element 31 which receives a sub-beam comprising of a +1th order diffracted light, a second light receiving element 32 which receives a zero-order light beam, and a third light receiving element 33 which receives a −1th order diffracted light.

The second light receiving element 32 is, similarly to the first embodiment, provided with a plurality of light receiving faces, i.e., a first, a second, a third and a fourth light receiving faces “A”, “B”, “C”, “D” which are formed in a cross-in-square shape for receiving a return light beam guided through the first, the second, the third and the fourth divided lens surfaces 25A, 25B, 25C, 25D. Further, the first light receiving face “A” comprises a first divided light receiving area A₁ which is located on an opposite side to the second light receiving face “B” and a second divided light receiving area A₂ which is located on the boundary area side with the second light receiving face “B”. The second light receiving face “B” comprises a first divided light receiving area B₁ which is located on the boundary side with the first light receiving face “A” and a second divided light receiving area B₂ which is located on the opposite side to the first light receiving face “A”. The third light receiving face “C” comprises a first divided light receiving area C₁ which is located on the boundary side with the fourth light receiving face “D” and a second divided light receiving area C₂ which is located on the opposite side to the fourth light receiving face “D”. The fourth light receiving face “D” comprises a first divided light receive area D₁ which is located on an opposite side to the third light receiving face “C” and a second divided light receiving area D₂ which is located on the boundary area side with the third light receiving face “C”. A boundary line between the first divided light receiving area A₁ and the second divided light receive area A₂ of the first light receiving face “A” is set at a position where a beam spot converged on the first light receiving face “A” is equally divided each other at the focal position. A boundary line between the first divided light receiving area B₁ and the second divided light receive area B₂ of the second light receiving face “B” is set at a position where a beam spot converged on the second light receiving face “B” is equally divided each other at the focal position. A boundary line between the first divided light receiving area C₁ and the second divided light receive area C₂ of the third light receiving face “C” is set at a position where a beam spot converged on the third light receiving face “C” is equally divided each other at the focal position. Further, a boundary line of the first divided light receiving area D₁ and the second divided light receive area D₂ of the fourth light receiving face “D” is set at a position where a beam spot converged on the fourth light receiving face “D” is equally divided each other at the focal position.

In the photo-detector 3 as constructed above, beams as shown in FIG. 7(B) are formed on four light receiving faces “A”, “B”, “C”, “D” at the time of focusing, beams as shown in FIG. 7(A) are formed at the time of a far side unfocusing, and beams as shown in FIG. 7(C) are formed at the time of a near side unfocusing.

Therefore, a focusing error signal is generated based on a difference between the sum of detection signals in the divided light receiving areas A₁, B₂, C₁, D₂, and the sum of detection signals in the divided light receiving areas A₂, B₁, C₂, D₁ in the plurality of the divided light receiving areas formed in the second light receiving element 32 of the photo-detector 3. In other words, when signals which are respectively detected in the divided light receiving areas A₁, A₂, B₁, B₂, C₁, C₂, D₁, D₂ are expressed as signals A₁, A₂, B₁, B₂, C₁, C₂, D₁, D₂, the focusing error signal is obtained by the following expression:
(A₁+B₂+C₁+D₂)−(A₂+B₁+C₂+D₁)

A tracking error signal can be obtained by either of the push-pull method and the three-beam method. Further, as shown in FIGS. 7(A) through 7(C), the first light receiving element 31 in the photo-detector receiving the sub-beam comprising of the +1th order diffracted light and the third light receiving element 33 receiving the −1th order diffracted light are respectively divided into four portions, and thus a tracking error signal can be detected by the DPP method.

In the first and second embodiments described above, the light receiving position in the fourth light receiving face “D” of the return light beam emitted through the first divided lens surface 25A and the light receiving position in the third light receiving face “C” of the return light beam emitted through the third divided lens surface 25C are completely shifted from each other in the jitter direction. In addition, the light receiving position in the second light receiving face “B” of the return light beam emitted through the second divided lens surface 25B and the light receiving position in the first light receiving face “A” of the return light beam emitted through the fourth divided lens surface 25D are also completely shifted from each other in the jitter direction.

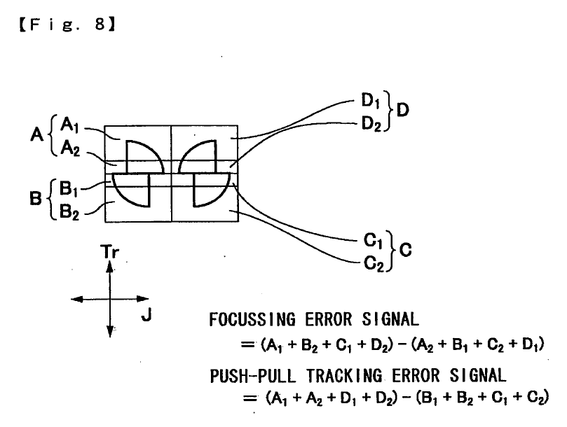

However, the respective divided lens surfaces 25A, 25B, 25C, 25D of the sensor lens may be constructed such that the light receiving condition of the return light beam at the time of focusing is illustrated as shown in FIG. 8. In other words, the light receiving position in the fourth light receiving face “D” of the return light beam emitted through the first divided lens surface 25A and the light receiving position in the third light receiving face “C” of the return light beam emitted through the third divided lens surface 25C are partially overlapped each other in the jitter direction, and the light receiving position in the second light receiving face “B” of the return light beam emitted through the second divided lens surface 25B and the light receiving position in the first light receiving face “A” of the return light beam emitted through the fourth divided lens surface 25D are partially overlapped each other in the jitter direction.

Further, not shown in the drawing, the respective divided lens surfaces 25A, 25B, 25C, 25D of the sensor lens may be constructed in the following manner. In other words, the light receiving position in the fourth light receiving face “D” of the return light beam emitted through the first divided lens surface 25A and the light receiving position in the third light receiving face “C” of the return light beam emitted through the third divided lens surface 25C are completely overlapped each other in jitter direction, and the light receiving position in the second light receiving face “B” of the return light beam emitted through the second divided lens surface 25B and the light receiving position in the first light receiving face “A” of the return light beam emitted through the fourth divided lens surface 25D are completely overlapped each other in the jitter direction.

In either of the embodiments, the area of the light receiving face of the photo-detector 3 can be reduced, and the size and the cost of the photo-detector 3 can be reduced.

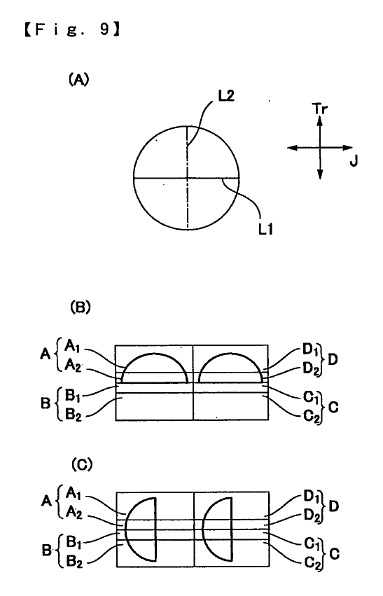

Further, in the embodiment as described above, a bifocal four-divided lens is used for the sensor lens 25. However, as shown in FIG. 9(A), a bifocal two-divided lens may be used in which its lens surface is divided into two portions by the dividing line L1. In this case, since beams are formed as shown in FIG. 9(B), a focusing signal can be generated on the basis of the detection results of the light receiving faces “A”, “D” of the photo-detector 3 by using the following expression:
(A₁+D₂)−(A₂+Dₗ)

Further, another bifocal two-divided lens may be used in which its lens surface is divided into two portions by the dividing line L2 shown in FIG. 9(A). In this case, since beams are formed as shown in FIG. 9(C), a focusing signal can be generated on the basis of the detection results of the light receiving faces “A”, “B”, “C”, “D” of the photo-detector 3 by using the following expression:
(A₁+B₂+C₁+D₂)−(A₂+B₁+C₂+D₁)

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

While the preferred embodiments of the present invention have been described using specific terms, such description is for illustrative purposes only, and it is to be understood that changes and variations may be made without departing from the spirit or scope of the appended claims.

What is claimed is:

1. An optical recording device for use with an optical recording disk comprising:
a laser light source;
a photo-detector which is provided with a plurality of light receiving faces;
an optical system which forms a forward path for guiding a laser beam emitted from the laser light source to the optical recording disk and a return path for guiding a return light beam reflected by the optical recording disk to the photo-detector; and
a sensor lens which is disposed at a middle position of the return path of the optical system, the sensor lens being provided with a plurality of divided lens surfaces whose focal lengths differ from each other and which guide the return light beam to different positions on the photo-detector,
wherein the plurality of light receiving faces of the photo-detector receive the return light beams guided by the plurality of divided lens surfaces, and a focusing error signal is generated on the basis of respective light receiving results in the plurality of light receiving faces of the photo-detector.

2. The optical recording device according to claim 1, wherein the focusing error signal is generated on the basis of comparison result of beam sizes of the return light beams which are guided to the photo-detector through the respective divided lens surfaces of the sensor lens.

3. The optical recording device according to claim 2, wherein the plurality of divided lens surfaces includes two divided lens surfaces whose boundary extends in one of a tracking direction and a jitter direction of the optical recording disk, and focal lengths of the two divided lens surfaces differ from each other.

4. The optical recording device according to claim 3, wherein the plurality of divided lens surfaces includes two divided lens surfaces whose boundary extends in the tracking direction of the optical recording disk, and focal lengths of the two divided lens surfaces differ from each other.

5. The optical recording device according to claim 4, wherein
the sensor lens is provided with a first, a second, a third and a fourth divided lens surfaces which are arranged in a cross-in-square shape,
a boundary between the first divided lens surface and the second divided lens surface and a boundary between the third divided lens surface and the fourth divided lens surface are set to be in the jitter direction of the optical recording disk,
a boundary between the first divided lens surface and the fourth divided lens surface and a boundary between the second divided lens surface and the third divided lens surface are set to be in the tracking direction of the optical recording disk,
focal lengths of the first divided lens surface and the third divided lens surface at diagonal positions each other are set to be coincided, and focal lengths of the second divided lens surface and the fourth divided lens surface at diagonal positions each other are set to be coincided, and
the focal length of the first divided lens surface, the third divided lens surface and the focal length of the second divided lens surface, the fourth divided lens surface are differed from each other.

6. The optical recording device according to claim 5, wherein
a return light beam emitted through the first divided lens surface and a return light beam emitted through the third divided lens surface are received at positions so as to be partially overlapped each other in the jitter direction of the optical recording disk, and
a return light beam emitted through the second divided lens surface and a return light beam emitted through the fourth divided lens surface are received at positions so as to be partially overlapped each other in the jitter direction of the optical recording disk.

7. The optical recording device according to claim 4, wherein
the photo-detector is provided a first, a second, a third and a fourth light receiving faces which are formed in a cross-in-square shape for receiving a return light beam guided through the sensor lens,
a boundary between the first light receiving face and the second light receiving face and a boundary between the third light receiving face and the fourth light receiving face are extended in the jitter direction of the optical recording disk,
a boundary between the first light receiving face and the fourth light receiving face and a boundary between the second light receiving face and the third light receiving face are extended in the tracking direction of the optical recording disk,
the first light receiving face comprises a first divided light receiving area A₁ which is located on an opposite side to the second light receiving face and a second divided light receiving area A₂ which is located on a boundary area side with the second light receiving face,
the second light receiving face comprises a first divided light receiving area B₁ which is located on a boundary side with the first light receiving face and a second divided light receiving area B₂ which is located on an opposite side to the first light receiving face,
the third light receiving face comprises a first divided light receiving area C₁ which is located on a boundary side with the fourth light receiving face and a second divided light receiving area C₂ which is located on an opposite side to the fourth light receiving face,
the fourth light receiving face comprises a first divided light receive area D₁ which is located on an opposite side to the third light receiving face and a second divided light receiving area D₂ which is located on a boundary area side with the third light receiving face, and
the focusing error signal is generated based on a difference between the sum of detection signals in the divided light receiving areas A₁, B₂, C₁, D₂, and the sum of detection signals in the divided light receiving areas A₂, B₁, C₂, D₁.

8. The optical recording device according to claim 7, wherein a tracking error signal is generated based on a difference between the sum of detection signals in the divided light receiving areas A₁, A₂, D₁, D₂, and the sum of detection signals in the divided light receiving areas B₁, B₂, C₁, C₂.

9. The optical recording device according to claim 7, wherein
a boundary line between the first divided light receiving area A₁ and the second divided light receive area A₂ of the first light receiving face is set at a position where a beam spot converged on the first light receiving face is equally divided each other at the focal position,
a boundary line between the first divided light receiving area B₁ and the second divided light receive area B₂ of the second light receiving face is set at a position where a beam spot converged on the second light receiving face is equally divided each other at the focal position,
a boundary line between the first divided light receiving area C₁ and the second divided light receive area C₂ of the third light receiving face is set at a position where a beam spot converged on the third light receiving face is equally divided each other at the focal position, and
a boundary line of the first divided light receiving area D₁ and the second divided light receive area D₂ of the fourth light receiving face is set at a position where a beam spot converged on the fourth light receiving face is equally divided each other at the focal position.

10. The optical recording device according to claim 7, wherein
the sensor lens is provided with a first, a second, a third and a fourth divided lens surfaces which are arranged in a cross-in-square shape,
a boundary between the first divided lens surface and the second divided lens surface and a boundary between the third divided lens surface and the fourth divided lens surface are set to be in the jitter direction of the optical recording disk,
a boundary between the first divided lens surface and the fourth divided lens surface and a boundary between the second divided lens surface and the third divided lens surface are set to be in the tracking direction of the optical recording disk,
focal lengths of the first divided lens surface and the third divided lens surface at diagonal positions each other are set to be coincided, and focal lengths of the second divided lens surface and the fourth divided lens surface at diagonal positions each other are set to be coincided, and
the focal length of the first divided lens surface, the third divided lens surface and the focal length of the second divided lens surface, the fourth divided lens surface are differed from each other.
